(19) United States
(12) Patent Application Publication
(10) Pub. No.: US 2026/0295800 A1
(43) Pub. Date: Oct. 1, 2026

(54) POWER TOOL

(71) Applicant: Koki Holdings Co., Ltd., Tokyo (JP)

(72) Inventors: Kiyoto MATSUOKA, Ibaraki (JP); Yuta NOGUCHI, Ibaraki (JP)

(73) Assignee: Koki Holdings Co., Ltd., Tokyo (JP)

(21) Appl. No.: 19/489,883

(22) PCT Filed: Sep. 11, 2024
(86) PCT No.: PCT/JP2024/032481

§ 371 Date: Dec. 3, 2025

(30) Foreign Application Priority Data
Sep. 28, 2023 (JP) 2023-168906

(51) Int. Cl. B25F 5/00

(52) U.S. Cl. CPC B25F 5/00

(57) ABSTRACT

Provided is a work machine including: a motor; a mode switching portion configured to select one control mode from among a plurality of control modes by an operation of a worker; a drive operation portion configured to instruct starting or stopping of the motor by an operation of a worker; and a control portion configured to control driving of the motor based on the control mode selected when starting of the motor is instructed by the drive operation portion. The control mode is configured to switch sequentially each time the mode switching portion is operated, and control modes usable by an operation of the mode switching portion are selectable by wireless communication with an external device. and a number of usable control modes is capable of being reduced relative to a number at factory default.

### TECHNICAL FIELD

The present invention relates to a work machine.

### RELATED ART

Patent Document 1 discloses a work machine in which a drive mode for driving a motor can be selected by an external device.

### CITATION LIST

### Patent Documents

Patent Document 1: International Publication No. WO 2022/070760

### SUMMARY OF INVENTION

### Technical Problem

The present invention aims to provide a work machine with excellent operability.

### Solution to Problem

One aspect of the present invention is a work machine. The work machine includes a motor; a mode switching portion configured to select one control mode from among a plurality of control modes by an operation of a worker; a drive operation portion configured to instruct starting or stopping of the motor by an operation of a worker; and a control portion configured to control driving of the motor based on the selected control mode when starting of the motor is instructed by the drive operation portion. The control mode is configured to switch sequentially each time the mode switching portion is operated. Control modes usable by an operation of the mode switching portion are selectable by wireless communication with an external device, and a number of usable control modes is capable of being reduced relative to a number at factory default.

Another aspect of the present invention is a work machine. The work machine includes a motor; a mode switching portion configured to enable a first selection operation for selecting one control mode from among a first number of control modes by an operation of a worker; a drive operation portion configured to instruct starting or stopping of the motor by an operation of a worker; and a control portion configured to control driving of the motor based on the one control mode selected by the first selection operation when starting of the motor is instructed by the drive operation portion. The control portion may determine that a second selection operation has been executed to select a second number of control modes, which is less than the first number, from the first number of control modes as control modes selectable by the first selection operation, and the control portion is configured to limit the control modes selectable by the first selection operation to the second number of control modes in response to determining that the second selection operation has been executed.

Another aspect of the present invention is a work machine. The work machine includes a motor; a mode switching portion configured to enable a first selection operation for selecting one control mode from among a first number of control modes by an operation of a worker; a drive operation portion configured to instruct starting or stopping of the motor by an operation of a worker; a plurality of display portions corresponding to each of the first number of control modes; and a control portion configured to control driving of the motor based on the one control mode selected by the first selection operation in response to the motor being instructed to start by the drive operation portion, and to display a display portion corresponding to the one control mode among the plurality of display portions. The control portion may determine that a second selection operation has been executed to select a second number of control modes, which is less than the first number, from the first number of control modes as control modes selectable by the first selection operation and may determine that a third selection operation has been executed to select a third number of control modes, which is less than the first number, from the first number of control modes as control modes non-selectable by the first selection operation. The first number of control modes comprises a first control mode, a second control mode, and a third control mode, and at least the second control mode is configured to be selectable by the second selection operation, and the control portion is configured to: when the first control mode, the second control mode, and the third control mode are selected by the second selection operation, switch display portions corresponding to each control mode among the plurality of display portions in order of the first control mode, the second control mode, and the third control mode in response to the first selection operation to display a control mode selected by the first selection operation; and when the first control mode and the third control mode are selected by the second selection operation and the second control mode is selected by the third selection operation, switch display portions corresponding to each control mode among the plurality of display portions in order of the first control mode and the third control mode in response to the first selection operation to display the control mode selected by the first selection operation.

Another aspect of the present invention is a work machine. The work machine includes a motor; a mode switching portion configured to enable a first selection operation for selecting one control mode from among a first number of control modes by an operation of a worker; a drive operation portion configured to instruct starting or stopping of the motor by an operation of a worker; a plurality of display portions corresponding to each of the first number of control modes; and a control portion configured to control driving of the motor based on the one control mode selected by the first selection operation when starting of the motor is instructed by the drive operation portion. The control portion may determine that a second selection operation has been executed to select a second number of control modes, which is less than the first number, from the first number of control modes as control modes selectable by the first selection operation, and the control portion is configured to, in response to determining that the second selection operation has been executed, enable display of only display portions corresponding to control modes selectable by the first selection operation among the plurality of display portions. Further, the control portion is configured to, in response to execution of a second selection operation to select a second number of control modes, which is less than the first number, from the first number of control modes as control modes selectable by the first selection operation, enable selection of only the second number of control modes by the first selection operation, and enable display of only display portions corresponding to the control modes selected by the second selection operation.

The disclosure may be expressed as “electric equipment” or “power tool,” and such expressions are also valid as aspects of the disclosure.

### Effects of Invention

According to the present invention, a work machine with excellent operability may be provided.

### BRIEF DESCRIPTION OF THE DRAWINGS

FIG. 1 is conceptual diagram of a work machine system according to an embodiment of the present invention, showing a work machine system including a work machine 1, a battery pack 20, and a mobile terminal 80.

FIG. 2 is a side cross-sectional view of the work machine 1.

FIG. 3 (A) is a circuit block diagram of the work machine system shown in FIG. 1, showing a work machine system including the work machine 1, the battery pack 20, and the mobile terminal 80. (B) is an external view of the operation panel 11 of the work machine 1. (C) is an external view of the panel portion 27 of the battery pack 20.

FIG. 4 is a diagram showing a screen display of the mobile terminal 80, illustrating a screen display in a state where all control modes of the work machine 1 are enabled for use.

FIG. 5 is a diagram showing a screen display of the mobile terminal 80, illustrating a screen display in a state where control modes 2 and 3 of the work machine 1 are disabled for use.

FIG. 6 is a diagram showing a screen display of the mobile terminal 80, illustrating a screen display in a state where only control mode 0 of the work machine 1 is enabled for use.

FIG. 7 is a diagram showing a screen display of the mobile terminal 80, illustrating a screen for sorting control modes.

FIG. 8 is a flowchart of control mode switching of the work machine 1.

### DESCRIPTION OF EMBODIMENTS

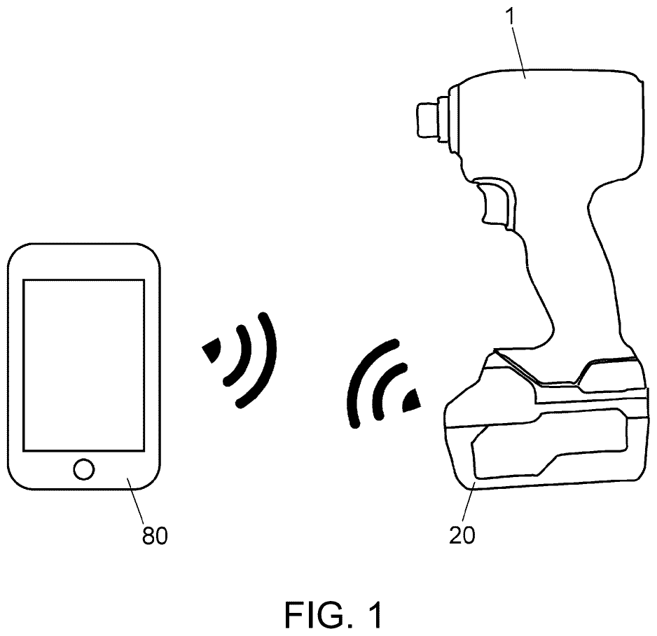

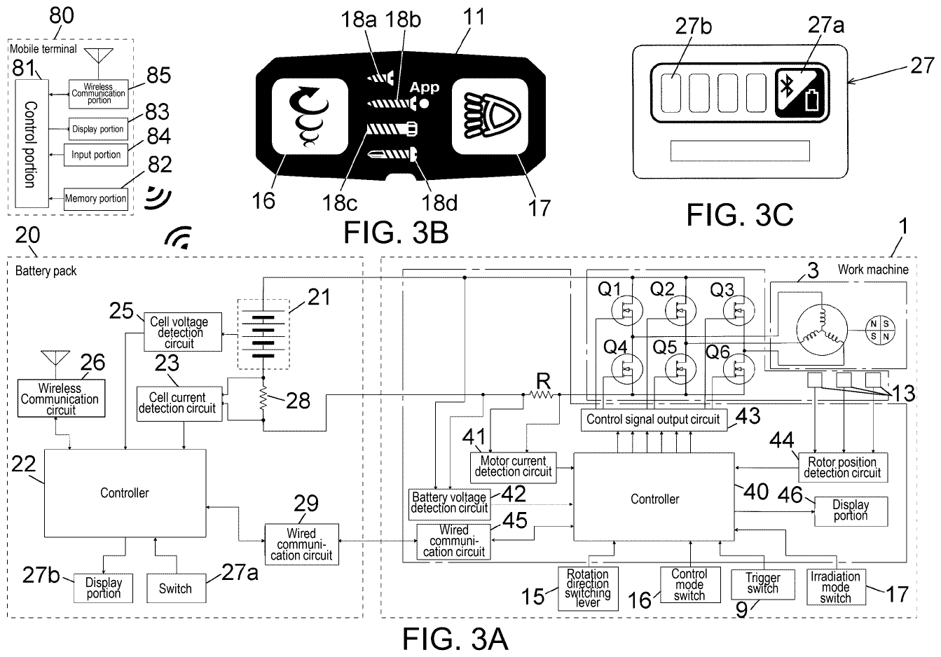

This embodiment relates to the work machine 1 and a work machine system. As shown in FIG. 1 and FIG. 3(A), the work machine system of this embodiment includes the work machine 1, the battery pack 20, and the mobile terminal 80 as an external device.

The battery pack 20 is a battery pack equipped with a wireless communication function and has a short-range wireless communication function such as Bluetooth (registered trademark). The mobile terminal 80 is a smartphone, tablet terminal, or the like, and has a short-range wireless communication function such as Bluetooth (registered trademark). The mobile terminal 80 and the battery pack 20 may perform wireless communication with each other via short-range wireless communication. The mobile terminal 80 may perform wireless communication with the work machine 1 via the battery pack 20 mounted on the work machine 1. A management application (hereinafter referred to as “management application”) for managing the work machine 1 is installed on the mobile terminal 80.

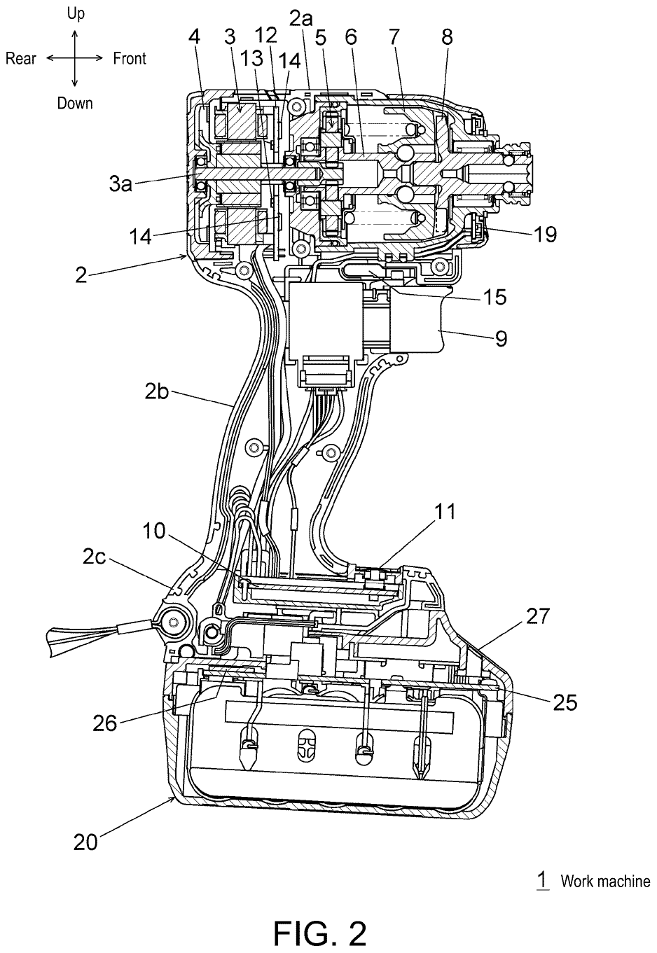

The work machine 1 is a power tool, specifically a cordless type impact driver. FIG. 2 defines front-rear and up-down directions that are orthogonal to each other in the work machine 1. The front-rear direction is a direction parallel to a central axis of an output shaft 3a of the motor 3 as a drive portion.

The work machine 1 includes the housing 2. The housing 2 includes a body portion (cylindrical portion) 2a, a handle portion 2b, and a battery pack mounting portion 2c. The body portion 2a of the housing 2 has a cylindrical shape, and a central axis thereof is parallel to the front-rear direction. An illumination LED 19 (illumination portion) that illuminates a work location is provided at a lower portion of a front end of the body portion 2a. The handle portion 2b extends downward from an intermediate portion of the body portion 2a. The battery pack mounting portion 2c is provided at a lower end portion of the handle portion 2b.

Inside the body portion 2a, a fan 4, a stator and a rotor of the motor 3, a sensor/inverter board 12, a planetary gear mechanism (speed reduction mechanism) 5, a spindle 6, a hammer 7, and an anvil 8 are provided in order from the rear. The fan 4 is directly connected to the output shaft 3a of the motor 3, rotates together with the motor 3, and generates cooling air inside the housing 2.

The motor 3 is an inner rotor type brushless motor here. The sensor/inverter board 12 is accommodated in the body portion 2a so as to be perpendicular to the front-rear direction. Specifically, the sensor/inverter board 12 is supported (fixed) by an insulator attached to the stator of the motor 3. The sensor/inverter board 12 has a magnetic sensor 13 such as a Hall IC mounted on a rear surface thereof, and has a plurality of switching elements 14 mounted on a front surface thereof. The magnetic sensor 13 is for detecting a rotational position of the motor 3. The switching elements 14 are for supplying current to the motor 3. The plurality of switching elements 14 correspond to switching elements Q1 to Q6 in FIG. 3(A).

The output shaft 3a of the motor 3 penetrates through the sensor/inverter board 12 and extends forward. The planetary gear mechanism 5 decelerates rotation of the motor 3 and transmits the rotation to the spindle 6. The hammer 7 rotates together with the spindle 6 and rotates or rotationally strikes the anvil 8. A tip tool such as a bit (not shown) is attached to the anvil 8. The anvil 8 functions as a tip tool holding portion. The spindle 6, the hammer 7, and the anvil 8 are examples of driven portions and constitute a well-known rotational striking mechanism (impact mechanism).

The handle portion 2b is a portion gripped by a user, and a trigger switch 9 is provided at a front portion of an upper end thereof. The trigger switch 9 is a drive operation portion for the user to switch between driving and stopping of the motor 3, A rotation direction switching lever 15 is provided at the upper end portion of the handle portion 2b. The rotation direction switching lever 15 is a rotation direction switching portion for the user to switch between forward rotation and reverse rotation of the motor 3.

A control board 10 is provided in an upper portion inside the battery pack mounting portion 2c. The control board 10 is accommodated in a circuit board case and coated with resin, and the circuit board case is supported by the battery pack mounting portion 2c. The control board 10 is provided with a controller 40 and the like shown in FIG. 3(A).

An operation panel 11 is provided on an upper surface of the battery pack mounting portion 2c. A configuration of the operation panel 11 will be described later. A battery pack 20 is connected to the battery pack mounting portion 2c. The battery pack 20 accommodates battery cells and also accommodates a battery control board 25. The battery control board 25 has a wireless communication circuit 26 mounted thereon for short-range wireless communication such as Bluetooth (registered trademark).

A panel portion 27 is provided on an outer surface of the battery pack 20. As shown in FIG. 3(C), the panel portion 27 is provided with a switch 27a and a display portion 27b. The switch 27a is an operation portion for displaying a remaining battery level of the battery pack 20 and switching on-off of a short-range wireless communication function. The display portion 27b includes four LEDs here. In the case of the switch 27a being pressed briefly, the display portion 27b lights up according to the remaining battery level. The greater the remaining battery level, the greater the number of lit LEDs in the display portion 27b. In response to the switch 27a being pressed and held, for example, an LED at, for example, a right end of the display portion 27b blinks, a wireless connection is established between the battery pack 20 and an external device, for example, a mobile terminal 80, and the LED switches from blinking to lighting upon completion of the connection. It is noted that two types of LEDs with different colors (e.g., green and blue) are provided at the right end portion of the display portion 27b, one for remaining battery level display and the other for wireless communication. One type of LED (e.g., green) is provided up to a third LED from a left end of the display portion 27b. In response to the switch 27a being pressed briefly, the four green LEDs light up according to the remaining battery level. In response to the switch 27a being pressed and held, the blue LED at the right end blinks or lights up. Each LED is mounted on the battery control board 25.

As shown in FIG. 3(B), the operation panel 11 includes a control mode switch 16 (control mode switching button), an irradiation mode switch 17 (irradiation mode switching button), and control mode display portions 18a to 18d. The control mode switch 16 is a mode switching portion for a user to switch a control mode of the work machine 1. An operation in which the user operates the control mode switch 16 to switch the control mode of the work machine 1 is a first selection operation. The irradiation mode switch 17 is an irradiation mode switching portion for the user to switch a lighting state of an illumination LED 19. The control mode display portions 18a to 18d, which are a plurality of display portions, each include an LED (light-emitting portion) and display a current control mode selected by the control mode switch 16. Types of control modes and a selection method will be described later.

FIG. 3(A) is a circuit block diagram of the work machine system shown in FIG. 1, and is a circuit block diagram of the work machine system including the work machine 1, the battery pack 20, and the mobile terminal 80.

The battery pack 20 includes a battery cell assembly 21, a controller 22 as a battery-side control portion, a cell current detection circuit 23, a cell voltage detection circuit 25, a wireless communication circuit 26 as a battery-side communication portion, a switch 27a, a display portion 27b, a resistor 28, and a wired communication circuit 29.

The battery cell assembly 21 includes a plurality of battery cells such as lithium-ion secondary battery cells. The number of series connections and the number of parallel connections of the plurality of battery cells are arbitrary, The cell current detection circuit 23 detects an output current of the battery cell assembly 21 based on a voltage of the resistor 28 provided in a path of the output current of the battery cell assembly 21, and transmits the detected output current to the controller 22. The cell voltage detection circuit 25 detects an output voltage of the battery cell assembly 21 and transmits the same to the controller 22. The controller 22 includes a microcontroller or the like. The controller 22 performs wired communication with the controller 40 of the work machine 1 via the wired communication circuit 29. The controller 22 controls the wireless communication circuit 26 and performs wireless communication with the mobile terminal 80. The controller 22 controls the display portion 27b in response to an operation of the switch 27a. The controller 22 includes a built-in memory (memory portion) that stores unique information of the battery pack 20, such as a model name and a serial number. The memory may be separate from the controller 22. The memory is configured as a non-volatile memory capable of retaining stored information even in a situation where power is not supplied. The wireless communication circuit 26 performs wireless communication with the wireless communication portion 85 of the mobile terminal 80. The controller 22 is also mounted on the battery control board 25.

The mobile terminal 80 includes a control portion 81 as a terminal-side control portion, a memory portion 82 as a terminal-side memory portion, a display portion 83, an input portion 84, and a wireless communication portion 85 as a terminal-side communication portion. Although not illustrated, the mobile terminal 80 includes a built-in secondary battery that serves as its own power source. In the case of the mobile terminal 80 being a smartphone or a tablet terminal, a screen of the smartphone or the tablet terminal serves as the display portion 83 and also serves as the input portion 84. The wireless communication portion 85 has a short-range wireless communication function such as Bluetooth (registered trademark) and communicates with the wireless communication circuit 26 of the battery pack 20. A management application is installed in the memory portion 82. The control portion 81 executes each function of the management application. Display on the display portion 83 by the management application will be described later.

In the work machine 1, switching elements Q1 to Q6 provided on the sensor/inverter board 12 are connected in a three-phase bridge configuration and constitute an inverter circuit. The switching elements Q1 to Q6 perform switching operations according to control by the controller 40 and supply drive power to the motor 3. The magnetic sensor 13 provided on the sensor/inverter board 12 transmits an electrical signal corresponding to a rotational position of the motor 3 to the rotor position detection circuit 44.

The control board 10 is provided with a controller 40 as a device-side control portion, a motor current detection circuit 41, a battery voltage detection circuit 42, a control signal output circuit 43, a rotor position detection circuit 44, a wired communication circuit 45, and a display portion 46.

The motor current detection circuit 41 detects a current of the motor 3 (hereinafter “motor current”) based on a voltage of a resistor R provided in a current path of the motor 3, and outputs the same to the controller 40. The battery voltage detection circuit 42 detects an output voltage of the battery pack 20 and outputs the detected voltage to the controller 40. The control signal output circuit 43 applies control signals (e.g., PWM signals) to respective control terminals of the switching elements Q1 to Q6 according to control by the controller 40. The rotor position detection circuit 44 detects a rotational position of the motor 3 based on a signal from the magnetic sensor 13 and outputs the same to the controller 40. The display portion 46 is a functional block corresponding to the control mode display portions 18a to 18d illustrated in FIG. 3(B), and displays a current control mode according to control by the controller 40.

The controller 40 includes a built-in memory (memory portion) that stores unique information of the work machine 1, usage history information of the work machine 1, operation parameters for driving the motor 3, usage availability of each control mode, a switching order of control modes associated with operation of the control mode switch 16, a last used control mode, and the like. The operation parameters include those added and edited by a management application of the mobile terminal 80. The memory may be separate from the controller 40. The memory is configured as a non-volatile memory capable of retaining stored information even in a situation where power is not supplied. The controller 40 detects a rotation speed of the motor 3 (hereinafter “motor rotation speed”) based on an output signal of the rotor position detection circuit 44. The controller 40 performs wired communication with the controller 22 of the battery pack 20 via the wired communication circuit 45. The controller 40 controls on-off of the switching elements Q1 to Q6 via the control signal output circuit 43 (e.g., PWM control) according to a current control mode, a rotation direction supported by the rotation direction switching lever 15, and operation of the trigger switch 9, thereby controlling driving of the motor 3. The controller 40 controls driving of the motor 3 while monitoring a rotational position, the motor rotation speed, and the motor current of the motor 3.

Control modes of the work machine 1 are as follows. Differences among the control modes mainly include a no-load rotation speed of the motor 3 (a rotation speed when a pull amount of the trigger switch 9 is at maximum, hereinafter “no-load rotation speed”), a pull range of the trigger switch 9 (a manner in which the motor rotation speed increases according to the pull amount of the trigger switch 9), and the motor rotation speed and power under load or after start of impact. It is noted that “no-load” indicates a state in which no external load is applied to a tip tool attached to the tip tool holding portion (anvil 8) or to the motor 3. It is noted that when an operator operates the trigger switch 9, the motor 3 is started and driven in a selected control mode.
Control mode 0 (soft mode) . . . a mode in which the no-load rotation speed is low and the motor rotation speed and power after the start of impact are also set low, and is a mode for delicate work. In control mode 0, the control mode display portion 18 a of the operation panel 11 shown in FIG. 3(B) lights up in red.
Control mode 1 (power mode) . . . a mode in which the no-load rotation speed is high and the motor rotation speed and power after the start of impact are also set high, and is a mode that may be widely used from general work to high-load work. Under no-load, the rotation speed changes finely according to how the trigger switch 9 is pulled. In control mode 1, the control mode display portion 18b of the operation panel 11 shown in FIG. 3(B) lights up in red.
Control mode 2 (App mode) (Optional) . . . one of the modes that may be added by a “management application” of the mobile terminal 80, and an operation feeling of the trigger switch 9 under no-load may be arbitrarily set based on the power mode. Parameters that may be changed include a play amount of the trigger switch 9 (a pull amount until the motor 3 starts rotating), a minimum rotation speed (a rotation speed when rotation of the motor 3 starts), a maximum rotation speed (a maximum rotation speed of the motor 3), a soft start (a manner in which the motor rotation speed increases when the trigger switch 9 is pulled), and a width of a low-speed range (a motor rotation speed corresponding to the pull amount of the trigger switch 9). In control mode 2, the control mode display portion 18b of the operation panel 11 shown in FIG. 3(B) lights up in blue.
Control mode 3 (thin screw mode) (Optional) . . . one of modes that may be added by the management application, and is a mode for work of tightening screws that are prone to cam-out, such as thin screws. Until impact starts, an electronic pulse operation that alternately repeats forward rotation and reverse rotation is executed. In control mode 3, a specific operation is performed regardless of the pull amount of the trigger switch 9. In control mode 3, the control mode display portion 18b of the operation panel 11 shown in FIG. 3(B) blinks in blue.
Control mode 4 (bolt continuous mode) . . . a mode for work of tightening bolts. The control is similar to the power mode, but the no-load rotation speed is set lower than the power mode, and a pull range of the trigger switch 9 is short (the maximum rotation speed is reached even with a small pull amount). In control mode 4, the control mode display portion 18c of the operation panel 11 shown in FIG. 3(B) lights up in red.
Control mode 5 (bolt single mode) . . . a mode for delicate work of retightening bolts or bolt tightening. Under no-load, it is the same as the bolt continuous mode, but when impact is performed, it stops immediately. Further, when reverse rotation work is performed in control mode 5, a reverse auto-slow function that reduces the rotation speed when it is detected that a bolt has come off becomes effective. In control mode 5, the control mode display portion 18c of the operation panel 11 shown in FIG. 3(B) blinks in red.
Control mode 6 (Teks mode) . . . a mode for Teks screw tightening, and the no-load rotation speed is set to the highest, but when impact starts, the rotation speed and power are reduced to prevent breakage of the screw. In control mode 6, the control mode display portion 18d of the operation panel 11 shown in FIG. 3(B) lights up in green.

Among control modes 0 to 6, control modes 2 and 3 are control modes that are not enabled in the initial state (factory default state), and are control modes that may be arbitrarily enabled by the user through the management application (hereinafter also referred to as “application modes”). Among the application modes, parameters of control mode 2 may be arbitrarily set by the user through the management application, and parameters of control mode 3 may not be changed. Control modes 0, 1, and 4 to 6 are control modes that are enabled from the initial state (factory default state) (hereinafter also referred to as “unique modes”), and are control modes whose parameters may not be changed. Here, seven control modes 0 to 6, or five control modes 0, 1, and 4 to 6, are a first number indicating the number of control modes.

Control modes 0, 1, 4, and 6 are examples of a plurality of control modes that differ from each other in no-load rotation speed (motor rotation speed in a no-load state). Control modes 3, 5, and 6 are examples of a plurality of control modes that change the drive mode of the motor 3 during a single motor drive operation on the trigger switch 9. Control modes 0 to 2 and 4 are examples of a plurality of control modes that do not change the drive mode of the motor 3 during a single motor drive operation on the trigger switch 9.

The user may sequentially switch the control mode of the work machine 1 by operating (pushing) the control mode switch 16 (executing a first selection operation). The user may arbitrarily select whether to use any multiple control modes among control modes 0 to 6 through the function of the management application of the mobile terminal 80. Here, the operation in which the user arbitrarily selects any multiple control modes among control modes 0 to 6 through the function of the management application of the mobile terminal 80 is a second selection operation. The control modes selected by this second selection operation become usable, and by operating the control mode switch 16, any control mode may be selected from among the selected control modes to drive the motor 3. On the other hand, the operation in which the user does not arbitrarily select any multiple control modes among control modes 0 to 6 through the function of the management application of the mobile terminal 80 is a third selection operation. The control modes not selected by this third selection operation become unusable and may be selected even by operating the control mode switch 16. That is, whether each of the plurality of control modes may be used may be selected by the second selection operation and the third selection operation. However, at least one control mode among control modes 0 to 6 needs to be selected as usable (it is not possible to select all control modes as disabled). The display portions 18a to 18 may display only the control modes selected as usable (usage permitted) among control modes 0 to 6. That is, the display portions 18a to 18 do not display the control modes selected as disabled (unusable) among control modes 0 to 6. The user may select only the control modes selected as usable among control modes 0 to 6 by operating the control mode switch 16. That is, the user may not select the control modes selected as disabled among control modes 0 to 6 by operating the control mode switch 16. The number of control modes selected as usable is a second number.

As an example, in the case where the work machine 1 is in an initial state (factory default state), each time the control mode switch 16 is operated, the control mode of the work machine 1 and the display of the control mode display portions 18a to 18d switch as follows. In this case, the first number is 5. Control mode 0 (soft mode, control mode display portion 18a lights up in red)→control mode 1 (power mode, control mode display portion 18b lights up in red)→control mode 4 (bolt continuous mode, control mode display portion 18c lights up in red)→control mode 5 (bolt single mode, control mode display portion 18c blinks in red)→control mode 6 (Teks mode, control mode display portion 18d lights up in green)→control mode 0 (same as above)→(hereinafter, repetition of similar mode transitions)

As another example, in the case where the user operates the management application from the initial state (factory default state) and selects control modes 5 and 6 as disabled (third selection operation), each time the control mode switch 16 is operated, the control mode of the work machine 1 and the display of the control mode display portions 18a to 18d switch as follows. In this case, the second number is 3. Further, the third number is 2. Control mode 0 (soft mode, control mode display portion 18a lights up in red)→control mode 1 (power mode, control mode display portion 18b lights up in red)→control mode 4 (bolt continuous mode, control mode display portion 18 c lights up in red)→control mode 0 (same as above)→(hereinafter, repetition of similar mode transitions) In the case of the above another example, the number of usable control modes (3) becomes less than the number of display portions 18a to 18d (4). That is, the control modes selectable by operating the control mode switch 16 are limited by operating the management application. It is noted that the above lighting colors are examples and may be arbitrarily changed. The controller 40 stores the last selected control mode, and at the next work, the control mode that was selected during the previous work is automatically selected.

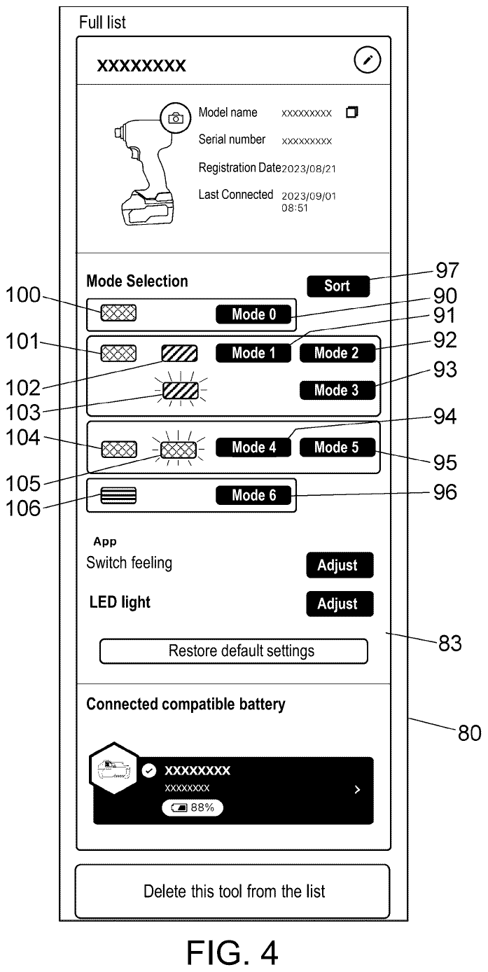

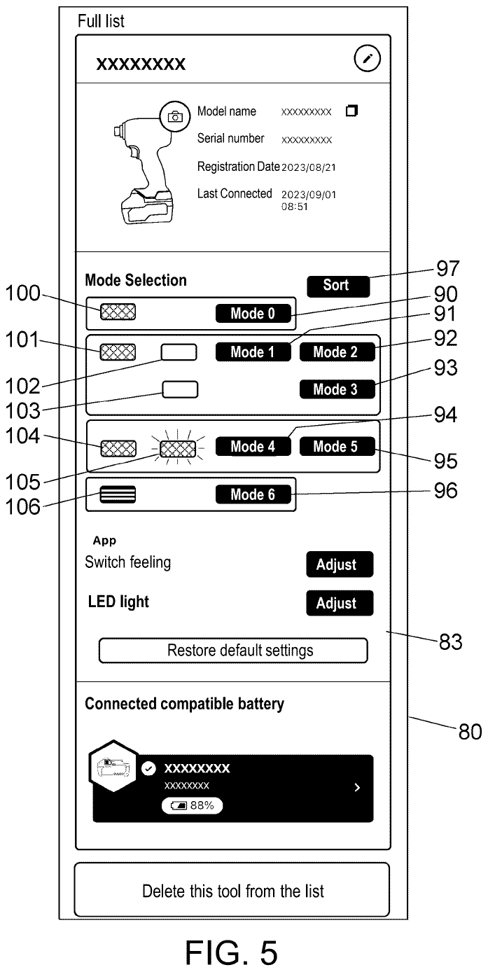

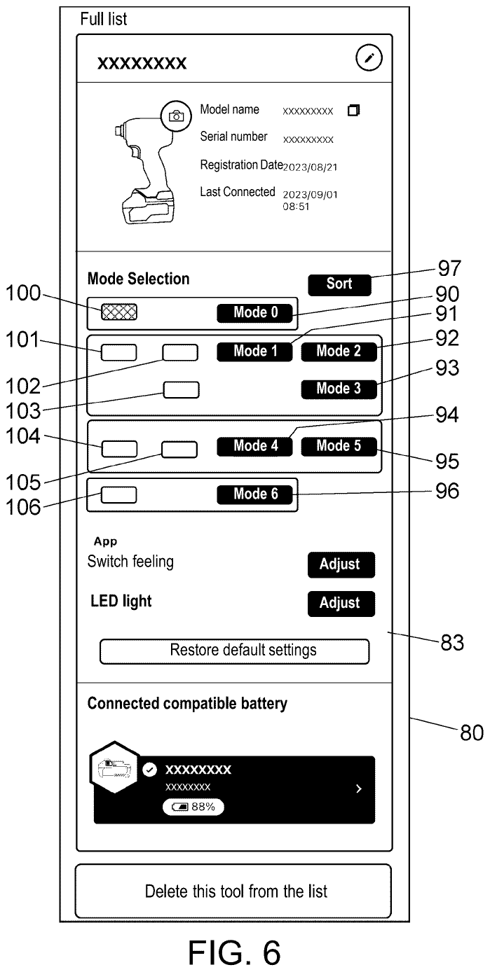

FIG. 4 to FIG. 6 are diagrams showing screen displays of the management application of the mobile terminal 80. FIG. 4 shows a screen display in a state where all control modes of the work machine 1 are set to enabled. FIG. 5 shows a screen display in a state where control modes 2 and 3 of the work machine 1 are set to disabled from the state of FIG. 4. FIG. 6 shows a screen display in a state where only control mode 0 of the work machine 1 is set to enabled.

The control mode usage availability selection buttons 90 to 96 shown in FIG. 4 to FIG. 6 are buttons for selecting the usage availability of control modes 0 to 6 of the work machine 1, respectively. Each time the user taps the control mode usage availability selection buttons 90 to 96, the usage availability of the corresponding control mode switches. That is, executing the second selection operation enables the control mode to be usable, and executing the third selection operation disables the control mode. The control mode usage availability display portions 100 to 106 are portions that display the usage availability of control modes 0 to 6 of the work machine 1, respectively. It is noted that in FIG. 4 to FIG. 6, three patterns of hatching in the control mode usage availability display portions 100 to 106 indicate differences in colors of red, blue, and green. Further, radial lines shown around the control mode usage availability display portions 103 and 105 indicate blinking. The display modes (display color and lighting or blinking) of the control mode usage availability display portions 100 to 106 are aligned with the display modes of the control mode display portions 18a to 18d in the corresponding control modes. Each of the second selection operation and the third selection operation may select two or more control modes among the plurality of control modes, or may select only one.

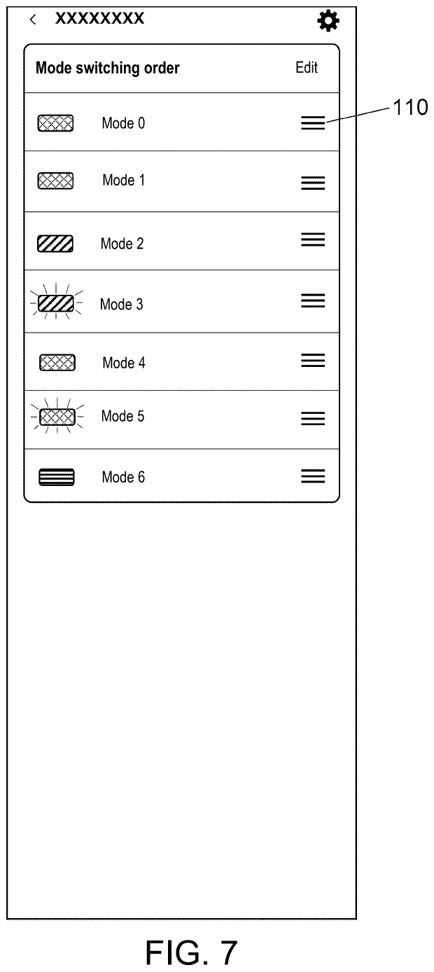

FIG. 7 is a diagram showing a screen display of the management application of the mobile terminal 80, showing a control mode sorting screen. In the case of tapping the sort button 97 on the screens of FIG. 4 to FIG. 6, the screen transitions to the screen shown in FIG. 7. On the screen of FIG. 7, a list of control modes is displayed, and the user may arbitrarily change the switching order of the control modes in the case of operating the control mode switch 16 by swiping the sort button 110 on the right side of the list up and down.

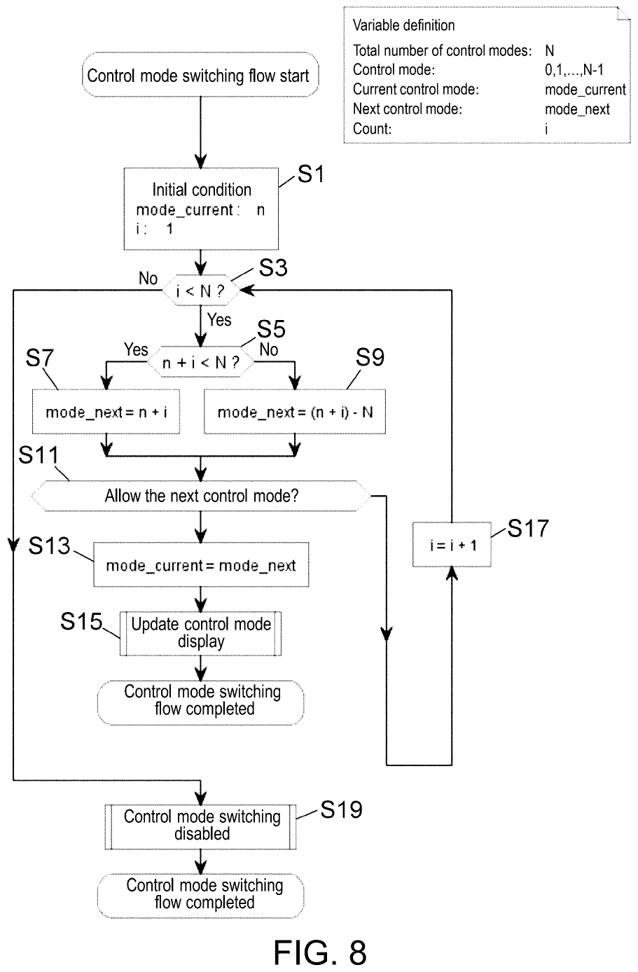

FIG. 8 is a flowchart of control mode switching in the work machine 1. This flowchart is started by operating the control mode switch 16 in a state where the trigger switch 9 is not operated. The total number N of control modes is seven, including control modes 0 to 6, in the present invention.

The controller 40, as an initial condition, substitutes a numerical value n (n is any of 0 to 6) corresponding to the current control mode into a variable mode current, and sets a counter i to 1. In the case of i<N (Yes in S3), the controller 40 substitutes n+i into a variable mode_next in the case of n+i<N (Yes in S5). In the case where n+i<N is not satisfied (No in S5), the controller 40 substitutes (n+i)-N into the variable mode_next (S9). In the case where use of the control mode specified by the value of the variable mode_next (any of 0 to 6) is permitted (Yes in S11), the controller 40 substitutes the value of the variable mode_next into the variable mode_current (S13), and updates the display of the control mode by the display portions 18a to 18d (S15).

In the case where i<N is not satisfied in S3 (No in S3), the controller 40 notifies the user that the control mode may not be switched, for example, by blinking all of the display portions 18a to 18d (S19). It is noted that the blinking at this time has a different cycle (e.g., a faster cycle) from the blinking used to display control modes 3 and 5. In this case, the display portions 18a to 18d also function as a notification portion. It is noted that a notification portion using light or sound may be provided separately from the display portions 18a to 18d. In the case where only one control mode is selected as usable, the value of the counter i becomes equal to N without the control mode being switched, and the process proceeds to No at the branch of S3.

The present invention has the following effects.
(1) The work machine 1 includes a controller 40 that controls the drive of the motor 3 in any one of a plurality of control modes, and is configured to allow arbitrary selection of whether at least one of the plurality of control modes may be used. The control mode display portions 18a to 18d are configured to display only the control modes selected as enabled among the plurality of control modes (control modes selected as disabled among the plurality of control modes are not displayed). The user may select only the control modes selected as enabled among the plurality of control modes by operating the control mode switch 16 (control modes selected as disabled among the plurality of control modes may not be selected by operating the control mode switch 16). Thus, by setting control modes with low usage frequency to disabled, the number of operations of the control mode switch 16 required to switch to a desired control mode may be reduced, and operability related to selection of control modes becomes favorable.
(2) The work machine 1 is configured to allow selection of whether two or more control modes among the plurality of control modes may be used. Thus, operability related to selection of control modes becomes more favorable compared to the case where only one control mode may be selected for usage availability.
(3) The work machine 1 is configured to allow arbitrary selection of whether at least one of the unique modes, that is, control modes that are enabled from the initial state (factory default state) and whose parameters cannot be changed (control modes 0, 1, 4 to 6), may be used. Thus, the work machine 1 may reduce the number of selectable control modes relative to the initial state (factory default state). Thus, operability related to selection of control modes becomes more favorable compared to the case where all unique modes are excluded from selection targets for usage availability. The greater the number of unique modes for which usage availability may be arbitrarily selected, the more favorable the operability related to selection of control modes becomes, and by allowing arbitrary selection of usage availability for all unique modes as in the above example, operability related to selection of control modes is significantly enhanced.
(4) In the case where only one control mode is selected as usable, when the control mode switch 16 is operated, the work machine 1 notifies the user by causing all of the display portions 18a to 18d to blink. Thus, discomfort to the user due to the control mode not switching even when the control mode switch 16 is operated may be reduced.
(5) The work machine 1 is configured to allow selection of an arbitrary control mode by operating a single control mode switch 16. Thus, the configuration related to control mode selection becomes simple.
(6) The work machine 1 is configured to allow arbitrary selection of usage availability of each control mode by the mobile terminal 80. Thus, the user may select usage availability of each control mode by operating the familiar mobile terminal 80, resulting in favorable operability.
(7) The work machine 1 may arbitrarily change the switching order of control modes when the control mode switch 16 is operated. Thus, unlike the case where the switching order of control modes when the control mode switch 16 is operated is fixed, customization to a switching order that is easy to use for each user is possible, and operability related to selection of control modes becomes favorable.

Although the present invention has been described above using the embodiment as an example, the present invention is not limited to the embodiment. Various modifications are possible within the scope of the claims for each matter specifically described in the embodiment.

The operation to disable a control mode is not limited to operating the management application of the mobile terminal 80, and may be, for example, an operation of long-pressing the control mode switch 16 in a state where the control mode desired to be disabled is selected. Further, for example, a configuration may be adopted in which all disabled control modes are reset to usable by an operation of simultaneously pressing the control mode switch 16 and the irradiation mode switch 17. Alternatively, a button for disabling a control mode or a button for resetting all disabled control modes to usable may be provided separately from the control mode switch 16 and the irradiation mode switch 17.

The work machine of the present invention is not limited to an impact driver, and may be other types such as a hammer drill, a driver drill, a circular saw, or the like. The number of control modes, control mode display portions, and the like exemplified as specific numerical values in the embodiment do not limit the scope of the invention in any way, and can be arbitrarily changed according to required specifications.

### REFERENCE SIGNS LIST

1 . . . Work machine, 2 . . . Housing, 2a . . . Body portion (cylindrical portion), 2b . . . Handle portion, 2c . . . Battery pack mounting portion, 3 . . . Motor (electric motor), 3a . . . Output shaft (rotating shaft), 4 . . . Fan, 5 . . . Planetary gear mechanism (speed reduction mechanism), 6 . . . Spindle, 7 . . . Hammer, 8 . . . Anvil, 9 . . . Trigger switch (drive operation portion), 10 . . . Control board, 11 . . . Operation panel, 12 . . . Sensor/inverter board, 13 . . . Magnetic sensor (Hall IC), 14 . . . Switching element, 15 . . . Rotation direction switching lever (rotation direction switching portion), 16 . . . Control mode switch (mode switching portion), 17 . . . Irradiation mode switch, 18a to 18d . . . Control mode display portion, 19 . . . Illumination LED (illumination portion), 20 . . . Battery pack, 21 . . . Battery cell assembly, 22 . . . Controller (battery-side control portion), 23 . . . Cell current detection circuit, 25 . . . Cell voltage detection circuit, 26 . . . Wireless communication circuit (wireless communication portion), 27 . . . Panel portion, 27a . . . Switch (operation button), 27b . . . Display portion, 40 . . . Controller (device-side control portion), 41 . . . Motor current detection circuit, 42 . . . Battery voltage detection circuit, 43 . . . Control signal output circuit, 44 . . . Rotor position detection circuit, 45 . . . Wired communication circuit, 46 . . . Display portion, 80 . . . Mobile terminal, 81 . . . Control portion (terminal-side control portion), 82 . . . Memory portion (terminal-side memory portion), 83 . . . Display portion, 84 . . . Input portion (operation portion), 85 . . . Wireless communication portion (terminal-side communication portion), 90 to 96 . . . Control mode usage availability selection button, 97 . . . Sort button, 100 to 106 . . . Control mode usage availability display portion, 110 . . . Sort button

1. A power tool having a handle portion gripped by a worker, and configured to process a workpiece with a tip tool, the power tool comprising:
a motor configured to drive the tip tool;
a drive operation portion configured to instruct starting or stopping of the motor by an operation of a worker;
a mode switching portion configured to select one control mode from among a plurality of control modes having different motor drive characteristics by an operation of a worker; and
a control portion configured to control driving of the motor based on the control mode selected when starting of the motor is instructed by the drive operation portion,
wherein the control mode is configured to switch sequentially each time the mode switching portion is operated, and
control modes usable by an operation of the mode switching portion are selectable by wireless communication with an external device, and a number of usable control modes is capable of being reduced relative to a number at factory default.

2. The power tool according to claim 1, wherein
the number of usable control modes is capable of being reduced by two or more relative to a number at factory default.

3. The power tool according to claim 1, wherein
the mode switching portion is configured to enable a first selection operation for selecting one control mode from among a first number of control modes by an operation of a worker, and
the control portion is configured to, when a second selection operation for selecting as a usable control mode a second number of control modes smaller than the first number from among the first number of control modes is executed by the external device as control modes selectable by the first selection operation, limit control modes selectable by the first selection operation to the second number of control modes.

4. The power tool according to claim 3, comprising
a plurality of display portions corresponding to each of the first number of control modes,
wherein the control portion is configured to enable display of only display portions corresponding to the control modes limited from among the plurality of display portions.

5. The power tool according to claim 4, wherein
the control portion is configured to enable selection of usage availability of two or more control modes from among the first number of control modes when a third selection operation for selecting as a unusable control mode a third number of control modes smaller than the first number from among the first number of control modes as control modes non-selectable by the first selection operation, or the second selection operation, is executed by the external device.

6. The power tool machine according to claim 5, wherein
the first number of control modes comprises a first control mode, a second control mode, and a third control mode, and at least the second control mode is configured to be selectable by the second selection operation, and
the control portion is configured to:
when the first control mode, the second control mode, and the third control mode are selected by the second selection operation, switch display portions corresponding to each control mode among the plurality of display portions in order of the first control mode, the second control mode, and the third control mode in response to the first selection operation to display a control mode selected by the first selection operation; and
when the first control mode and the third control mode are selected by the second selection operation and the second control mode is selected by the third selection operation, switch display portions corresponding to each control mode among the plurality of display portions in order of the first control mode and the third control mode in response to the first selection operation to display a control mode selected by the first selection operation.

7. The power toolwork according to claim 3, wherein
the first number of control modes include any of:
a plurality of control modes that differ from each other in a rotation speed of the motor in a no-load state where no external load is applied to the motor;
a plurality of control modes that change a drive mode of the motor during a single motor drive operation on the drive operation portion; and
a variable control mode that changes a drive mode of the motor during a single motor drive operation on the drive operation portion, and a fixed control mode that does not change a drive mode of the motor during a single motor drive operation on the drive operation portion.

8. The power tool according to claim 3, comprising
a notification portion configured to notify a user when the first selection operation is executed in a case where only one control mode is selected by the second selection operation.

9. A power tool having a handle portion gripped by a worker, and configured to process a workpiece with a tip tool, the power tool comprising:
a motor configured to drive the tip tool;
a drive operation portion configured to instruct starting or stopping of the motor by an operation of a worker;
a mode switching portion configured to enable a first selection operation for selecting one control mode from among a first number of control modes having different motor drive characteristics including a control mode that automatically change a drive mode of the motor during a single motor drive operation on the drive operation portion by an operation of a worker, the first number is a number at factory default or a total number; and
a control portion configured to control driving of the motor based on the one control mode selected by the first selection operation when starting of the motor is instructed by the drive operation portion;
wherein the control mode is configured to switch sequentially each time the mode switching portion is operated, and
wherein the control portion is configured to, when a second selection operation for selecting a second number of control modes smaller than the first number from among the first number of control modes by a control mode usage availability selection button is executed as control modes selectable by the first selection operation, limit control modes selectable by the first selection operation to the second number of control modes.

10. A power tool having a handle portion gripped by a worker, and configured to process a workpiece with a tip tool. the power tool comprising:
a motor configured to drive the tip tool;
a drive operation portion configured to instruct starting or stopping of the motor by an operation of a worker;
a mode switching portion configured to enable a first selection operation for selecting one control mode from among a first number of control modes having different motor drive characteristics including a control mode that automatically change a drive mode of the motor during a single motor drive operation on the drive operation portion by an operation of a worker, the first number is a number at factory default or a total number;
a plurality of display portions corresponding to each of the first number of control modes; and
a control portion configured to control driving of the motor based on the one control mode selected by the first selection operation when starting of the motor is instructed by the drive operation portion;
wherein the control mode is configured to switch sequentially each time the mode switching portion is operated, and
wherein the control portion is configured to, when a second selection operation for selecting a second number of control modes smaller than the first number from among the first number of control modes by a control mode usage availability selection button is executed as control modes selectable by the first selection operation, enable selection of only the second number of control modes by the first selection operation, and enable display of only display portions corresponding to control modes selected by the second selection operation.

11. The power tool according to claim 9, wherein
the second selection operation is configured to be executable by an external device or a button provided on the power tool.

12. The power toolwork according to claim 4, wherein
the plurality of display portions are configured to correspond to a plurality of control modes among the first number of control modes by changing a display method.

13. The power tool according to claim 4, wherein
a number of control modes selected by the second selection operation among the first number of control modes is made smaller than a number of the plurality of display portions.

14. The power toolwork according to claim 3, wherein
an order of control modes selected in response to the first selection operation is configured to be arbitrarily changeable by an external device.

15. The power tool according to claim 3, wherein
the second number selected by the second selection operation among the first number of control modes is made smaller than a number of control modes selectable in a factory default state.

16. The power tool according to claim 1, wherein
the different motor drive characteristics are at least one of a motor rotation speed when a pull amount of the drive operation portion is maximum, a manner in which the motor rotation speed increases according to the pull amount of the drive operation portion, and a motor rotation speed under load.

17. The power tool according to claim 9, wherein
an order of control modes selected in response to the first selection operation is configured to be arbitrarily changeable by an external device.

18. The power tool according to claim 9, wherein
the second number selected by the second selection operation among the first number of control modes is made smaller than a number of control modes selectable in a factory default state.

19. The power tool according to claim 10, wherein
an order of control modes selected in response to the first selection operation is configured to be arbitrarily changeable by an external device.

20. The power tool according to claim 10, wherein
the second number selected by the second selection operation among the first number of control modes is made smaller than a number of control modes selectable in a factory default state.
